(19) United States
(12) Patent Application Publication
(10) Pub. No.: US 2023/0039178 A1
(43) Pub. Date: Feb. 9, 2023

(54) SYSTEM AND METHOD FOR CONTROLLING NOZZLE OPERATION OF AN AGRICULTURAL SPRAYER

(71) Applicant: CNH Industrial America LLC, New Holland, PA (US)

(72) Inventors: Kevin M. Smith, Narvon, PA (US); Trevor Stanhope, Oak Lawn, IL (US)

(73) Assignee: CNH Industrial America LLC

(21) Appl. No.: 17/392,793

(22) Filed: Aug. 3, 2021

(51) Int. Cl. A01M 7/00; A01C 21/00; A01C 23/00; A01C 23/04

(52) U.S. Cl. CPC A01M 7/0089; A01C 21/007; A01C 23/007; A01C 23/047; A01M 7/0042

(57) ABSTRACT

An agricultural sprayer includes a nozzle assembly having a nozzle body, a valve moveably positioned within the nozzle body, and an actuator configured to move the valve within the nozzle body. Additionally, the agricultural sprayer includes a computing system having a spray controller positioned outside of the nozzle body and a nozzle controller positioned within the nozzle body. The spray controller is communicatively coupled to the nozzle controller such that the spray controller is configured to transmit control signals to the nozzle controller via a first communicative link, with the nozzle being controller configured to control an operation of the actuator based on the control signals received from the spray controller. Moreover, the spray controller is communicatively coupled to the actuator such that the spray controller is configured to directly control the operation of the actuator via a second communicative link independently of the nozzle controller.

### FIELD OF THE INVENTION

The present disclosure generally relates to agricultural sprayers and, more particularly, to systems and methods for control the operation of one or more nozzle assemblies of agricultural sprayer.

### BACKGROUND OF THE INVENTION

Agricultural sprayers apply an agricultural fluid (e.g., a pesticide, a nutrient, and/or the like) onto crops as the sprayer is traveling across a field. To facilitate such travel, sprayers are configured as self-propelled vehicles or implements towed behind an agricultural tractor or other suitable work vehicle. A typical sprayer includes a boom assembly on which a plurality of spaced apart nozzles is mounted. Each nozzle is configured to dispense or otherwise spray a fan of the agricultural fluid onto underlying crops and/or field surface.

In general, it may be necessary to deactivate or otherwise shut off the nozzles and then subsequently activate or turn on the nozzles at various instances during a spraying operation. For example, the nozzles may be shut off when the sprayer reaches a headland at the end of the pass (e.g., when turning around). Thereafter, the nozzles may be turned back on when the sprayer begins the subsequent pass across the field. However, current nozzle control systems can be slow to turn on and off the nozzles. Thus, with such systems, the sprayer may be several feet into the headland before the nozzles are shut off such that the agricultural fluid is dispensed onto a portion of the headland. Similarly, with such systems, the sprayer may be several feet into a new pass across the field before the nozzles are turned on such that the agricultural fluid is not dispensed onto a portion of the field.

Accordingly, an improved system and method for controlling nozzle operation of an agricultural sprayer would be welcomed in the technology. In particular, a system and method for controlling nozzle operation of an agricultural sprayer that allows for faster or more responsive nozzle control would be welcomed in the technology.

### SUMMARY OF THE INVENTION

Aspects and advantages of the technology will be set forth in part in the following description, or may be obvious from the description, or may be learned through practice of the technology.

In one aspect, the present subject matter is directed to an agricultural sprayer. The agricultural sprayer includes a frame and a tank supported on the frame, with the tank configured to store an agricultural fluid. Furthermore, the agricultural sprayer includes a boom assembly coupled to the frame, with the boom assembly having a nozzle assembly configured to dispense the agricultural fluid onto an underlying field. The nozzle assembly, in turn, includes a nozzle body, a valve moveably positioned within the nozzle body, and an actuator configured to move the valve within the nozzle body between an opened position and a closed position. Additionally, the agricultural sprayer includes a computing system having a spray controller positioned outside of the nozzle body and a nozzle controller positioned within the nozzle body. The spray controller is communicatively coupled to the nozzle controller such that the spray controller is configured to transmit control signals to the nozzle controller via a first communicative link, with the nozzle being controller configured to control an operation of the actuator based on the control signals received from the spray controller. Moreover, the spray controller is communicatively coupled to the actuator such that the spray controller is configured to directly control the operation of the actuator via a second communicative link independently of the nozzle controller.

In another aspect, the present subject matter is directed to a system for controlling nozzle operation of an agricultural sprayer. The system includes a nozzle assembly configured to dispense an agricultural fluid onto an underlying field. The nozzle assembly, in turn, includes a nozzle body, a valve moveably positioned within the nozzle body, and an actuator configured to move the valve within the nozzle body between an opened position and a closed position. In addition, the system includes a computing system including a spray controller positioned outside of the nozzle body and a nozzle controller positioned within the nozzle body. The spray controller is communicatively coupled to the nozzle controller such that the spray controller is configured to transmit control signals to the nozzle controller via a first communicative link, with the nozzle controller being configured to control an operation of the actuator based on the control signals received from the spray controller. Furthermore, the spray controller is communicatively coupled to the actuator such that the spray controller is configured to directly control the operation of the actuator via a second communicative link independently of the nozzle controller.

In a further aspect, the present subject matter is directed to a method for controlling nozzle operation of an agricultural sprayer. The agricultural sprayer, in turn, includes a nozzle assembly having a nozzle body. Additionally, the agricultural sprayer includes a computing system having a spray controller positioned outside of the nozzle body and a nozzle controller positioned within the nozzle body. The method includes receiving, with the spray controller, sensor data indicative of a location of the agricultural sprayer within a field. Moreover, the method includes identifying, with the spray controller, the presence of the weed or the presence of the nitrogen deficiency based on the received sensor data. In addition, when it is determined that the weed or the nitrogen deficiency is not present, the method includes transmitting, with the spray controller, control signals to the nozzle controller via a first communicative link, with the control signals instructing the nozzle controller to control an operation of an actuator of the nozzle assembly. Furthermore, when it is determined that the weed or the nitrogen deficiency is present, the method includes directly controlling, with the spray controller, the operation of the actuator via a second communicative link independent of the nozzle controller.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of one embodiment of an agricultural sprayer in accordance with aspects of the present subject matter;

FIG. 2 illustrates a cross-sectional view of one embodiment of a nozzle assembly of an agricultural sprayer in accordance with aspects of the present subject matter;

FIG. 3 illustrates a schematic view of one embodiment of a system for controlling nozzle operation of an agricultural sprayer in accordance with aspects of the present subject matter;

FIG. 4 illustrates a schematic view of one embodiment of a system for controlling nozzle operation of an agricultural sprayer in accordance with aspects of the present subject matter; and

FIG. 5 illustrates a flow diagram of one embodiment of a method for controlling nozzle operation of an agricultural sprayer in accordance with aspects of the present subject matter.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems and methods for controlling nozzle operation of an agricultural sprayer. As will be described below, the sprayer may include a boom assembly having one or more nozzle assemblies configured to dispense an agricultural fluid (e.g., a pesticide, a nutrient, etc.) onto the underlying field. Each nozzle assembly may, in turn, a nozzle body, a valve moveably positioned within the nozzle body, and an actuator configured to move the valve within the nozzle body between an opened position and a closed position. For example, in one embodiment, the actuator may correspond to a solenoid configured to move the valve between the opened and closed positions and an associated switching element (e.g., a relay, a field-effect transistor, etc.) configured to control the supply of power to the solenoid.

In several embodiments, the disclosed system may include a computing system configured to control the operation of the nozzle assembly(ies) of the sprayer. More specifically, the computing system may include a spray controller positioned outside of the nozzle assembly(ies) (e.g., within or adjacent to the cab of the sprayer). Furthermore, the computing system may also include one or more nozzle controllers, with each nozzle controller being positioned within the nozzle body of one of the nozzle assemblies. In this respect, the spray controller may be configured to transmit control signals to the nozzle controller(s) via a first communicative link (e.g., using a first communications protocol, such as CAN bus). Each nozzle controller may, in turn, be configured to control the operation of the actuator of the corresponding nozzle assembly (e.g., by controlling the operation of the corresponding switching element) based on the control signals received from the spray controller. Additionally, the spray controller may be communicatively coupled directly to the actuator (e.g., directly to its switching element) via a second communicative link. As such, the spray controller may be configured to directly control the operation of the actuator of each nozzle assembly via the second communicative link (e.g., using a second communications protocol, such as Modbus) independently of the nozzle controller(s).

Communicatively coupling the spray controller to the nozzle controller(s) via a first communicative link and directly to the nozzle assembly actuator(s) via a second communicative link improves the operation of the agricultural sprayer. More specifically, it is generally desirable to independently control the operation of each nozzle assembly. In such instances, the spray controller may transmit control signals to the nozzle controller(s) via the first communicative link. Based on the received control signals, each nozzle controller may adjust the operation of the corresponding nozzle assembly actuator independently of the other nozzle assembly actuators. Such control allows for independent adjustment of the duty cycle of each nozzle assembly based on the specific conditions of the portion of the field underlying that nozzle assembly.

However, in instances in which it desirable to quickly turn on or off the nozzle assemblies, such as when a weed is identified within the field, the latency associated with use of the first communicative link and the nozzle controller(s) may make such control of the nozzle assembly(ies) undesirable. Thus, in such instances, the spray controller may directly control the nozzle assembly actuator(s) via the second communicative link independently from the nozzle controller(s). Such direct control of the nozzle assembly actuator(s) allows the nozzle assembly(ies) to be turned on and off much quicker than when using the nozzle controller(s) and the first communicative link. Thus, the use of the second communicative link allows the nozzle assembly(ies) to be turned on or otherwise activated before the sprayer has passed the weed. Thus, the disclosed system and method allows the nozzle assemblies to be turned on and off quickly upon detection of weeds or other field conditions (e.g., a nitrogen deficiency), while still allowing for the nozzle assembly(ies) to be independently controlled from each other.

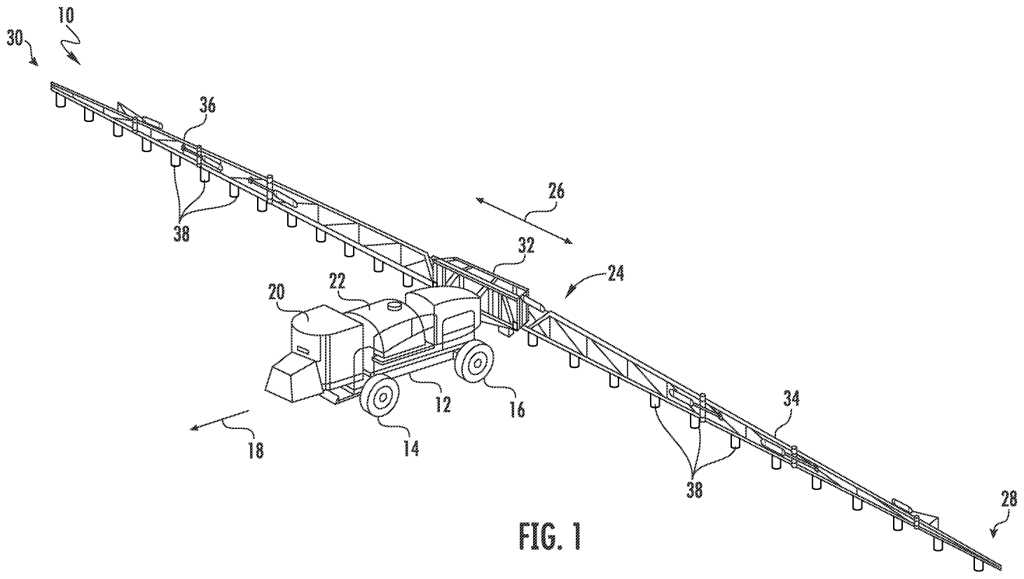

Referring now to the drawings, FIG. 1 illustrates a perspective view of one embodiment of an agricultural sprayer 10. In the illustrated embodiment, the agricultural sprayer 10 is configured as a self-propelled agricultural sprayer. However, in alternative embodiments, the agricultural sprayer 10 may be configured as any other suitable agricultural vehicle that dispenses an agricultural fluid (e.g., a pesticide or a nutrient) while traveling across a field, such as an agricultural tractor and an associated implement (e.g., a towable sprayer, an inter-seeder, a side-dresser, and/or the like).

As shown in FIG. 1, the agricultural sprayer 10 includes a frame or chassis 12 configured to support or couple to a plurality of components. For example, a pair of steerable front wheels 14 and a pair of driven rear wheels 16 may be coupled to the frame 12. The wheels 14, 16 may be configured to support the agricultural sprayer 10 relative to the ground and move the sprayer 10 in a direction of travel (indicated by arrow 18) across the field. Furthermore, the frame 12 may support a cab 20 and an agricultural fluid tank 22 configured to store or hold an agricultural fluid, such as a pesticide (e.g., a herbicide, an insecticide, a rodenticide, and/or the like), a fertilizer, or a nutrient. However, in alternative embodiments, the sprayer 10 may have any other suitable configuration. For example, in one embodiment, the front wheels 14 of the sprayer 10 may be driven in addition to or in lieu of the rear wheels 16.

Additionally, the sprayer 10 may include a boom assembly 24 mounted on the frame 12. In general, the boom assembly 24 may extend in a lateral direction (indicated by arrow 26) between a first lateral end 28 and a second lateral end 30, with the lateral direction 26 being perpendicular to the direction of travel 18. In one embodiment, the boom assembly 24 may include a center section 32 and a pair of wing sections 34, 36. As shown in FIG. 1, a first wing section 34 extends outwardly in the lateral direction 26 from the center section 32 to the first lateral end 28. Similarly, a second wing section 36 extends outwardly in the lateral direction 26 from the center section 32 to the second lateral end 30. Furthermore, a plurality of nozzles assemblies 38 may be supported on the boom assembly 24. As will be described below, each nozzle assembly 38 may, in turn, be configured to dispense the agricultural fluid stored in the tank 22 onto the underlying field. However, in alternative embodiments, the boom assembly 24 may have any other suitable configuration.

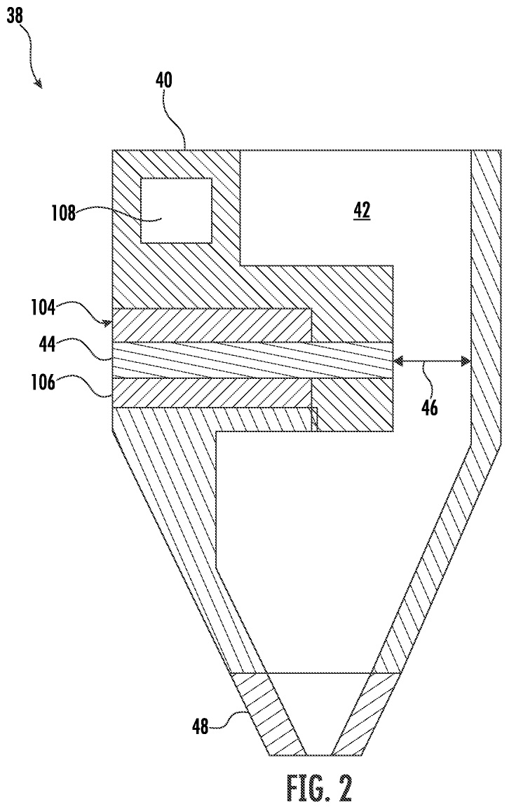

FIG. 2 illustrates a cross-sectional view of one embodiment of a nozzle assembly 38 of the agricultural sprayer 10. As shown, the nozzle assembly 38 includes a nozzle body or housing 40 defining a flow passage 42 therethrough. Moreover, the nozzle assembly 38 may include a valve 44 that is moveable (e.g., as indicated by arrow 46) between an opened position and a closed position. When at the opened position (e.g., as shown in FIG. 2), the agricultural fluid can flow through the flow passage 42 for dispensing onto the underlying field. Conversely, when at the closed position, the valve 44 blocks the flow passage 42 such that the agricultural fluid cannot flow through the nozzle assembly 38. In addition, the nozzle assembly 38 may include a nozzle tip 48 coupled to the nozzle body 40. The nozzle tip 48 may, in turn, control the geometry or other characteristics of the fan of agricultural fluid being dispensed by the nozzle assembly 38. However, in alternative embodiments, the nozzle assembly 38 may have any other suitable configuration.

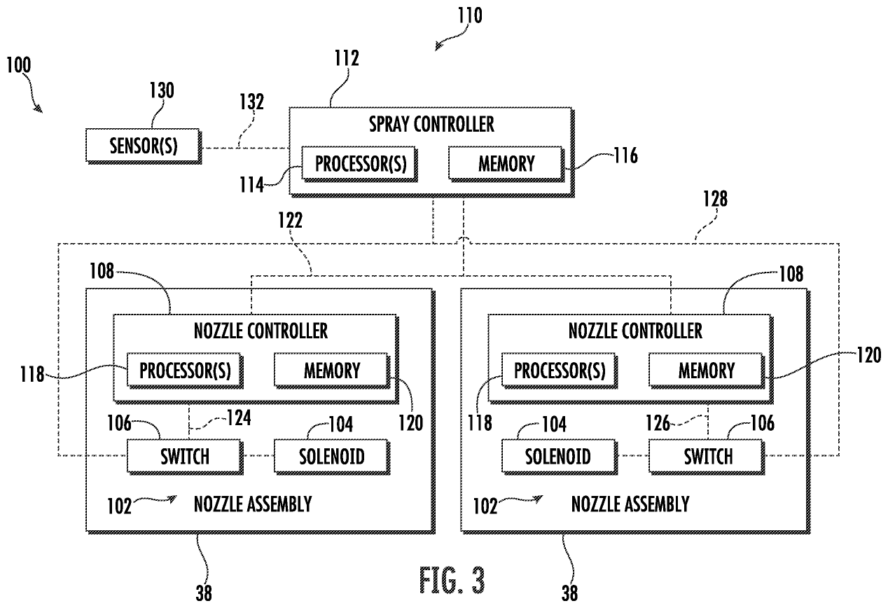

Additionally, the nozzle assembly 38 may include an actuator 102 at least partially positioned within the nozzle body 40. In general, the actuator 102 may be configured to move the valve 44 between the opened and closed positions. For example, in some embodiments, the actuator 102 may correspond to a solenoid 104 configured to move the valve 44 between the opened and closed positions and an associated switching element 106 (FIG. 3), such as a relay, field-effect transistor, and/or the like, that is configured to control the supply of power to the solenoid 104. In this respect, by controlling the power supply to the solenoid 104 via the switching element 106, the duty cycle of the valve 44 can be adjusted to vary the amount of agricultural fluid being dispensed by the nozzle assembly 38. However, in alternative embodiments, the actuator 102 may be configured as any other suitable device configured to move the valve 44 between the opened and closed positions, such as a stepper motor.

In addition, the nozzle assembly 38 may include a nozzle controller 108. Specifically, in several embodiments, the nozzle controller 108 may be positioned within or otherwise associated with the nozzle assembly 38. For example, as shown, in one embodiment, the nozzle controller 108 may be positioned within the nozzle body 40. As will be described below, the nozzle controller 108 may be configured to control the operation of the actuator 102, such as by actuating the switching element 106 on and off to control the power supplied to the solenoid 104.

It should be further appreciated that the configuration of the agricultural sprayer 10 described above and shown in FIGS. 1 and 2 is provided only to place the present subject matter in an exemplary field of use. Thus, it should be appreciated that the present subject matter may be readily adaptable to any manner of agricultural sprayer configuration.

Referring now to FIG. 3, a schematic view of one embodiment of a system 100 for controlling nozzle operation of an agricultural sprayer is illustrated in accordance with aspects of the present subject matter. In general, the system 100 will be described herein with reference to the agricultural sprayer 10 described above with reference to FIGS. 1 and 2. However, it should be appreciated by those of ordinary skill in the art that the disclosed system 100 may generally be utilized with agricultural sprayers having any other suitable sprayer configuration.

As shown in FIG. 3, the system 100 includes a computing system 110 having a spray controller 112. Specifically, in several embodiments, the spray controller 112 may be positioned outside of the nozzle assemblies 38 (e.g., outside of the nozzle body(ies) 40). Thus, in one embodiment, the spray controller 112 may be positioned within or adjacent to the cab 20 of the sprayer 10. As will be described below, the spray controller 112 may be configured to control the operation the nozzle assembly(ies) 38 of the sprayer 10 either directly or indirectly via the nozzle controller(s) 108.

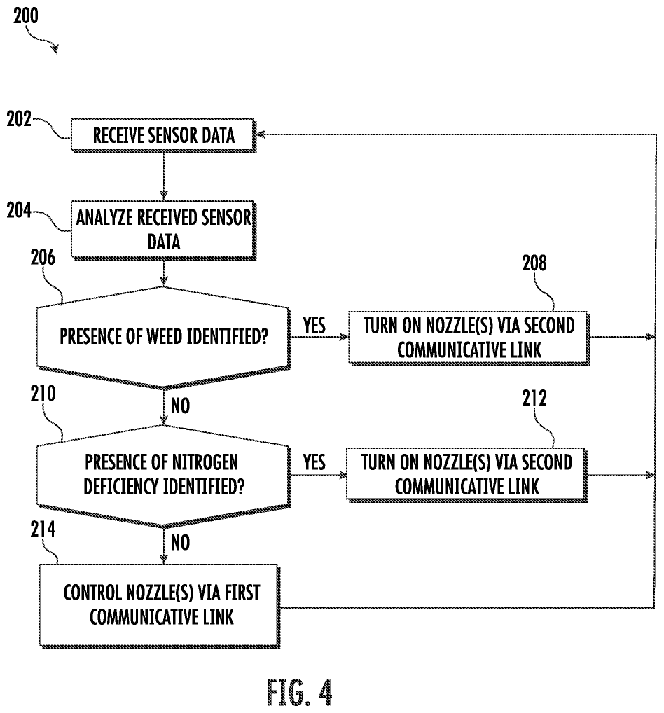

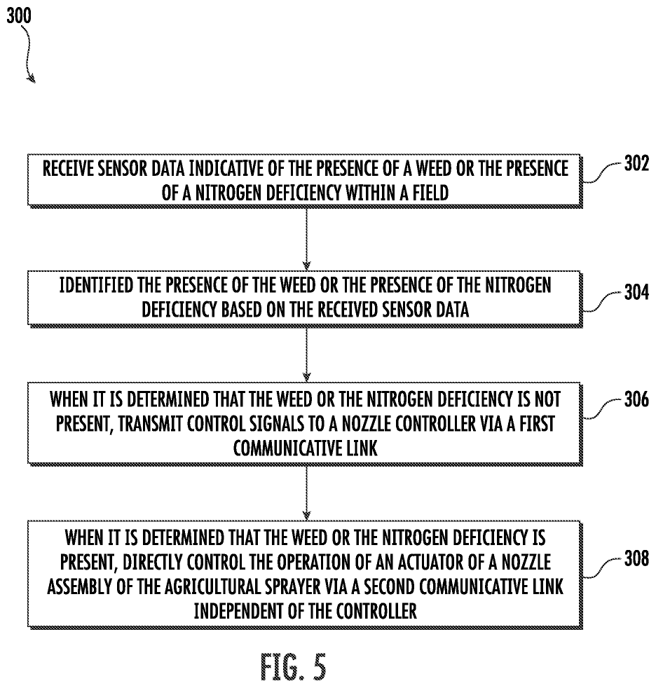

In general, the spray controller 112 may comprise any suitable processor-based device known in the art, such as a computing device or any suitable combination of computing devices. Thus, in several embodiments, the spray controller 112 may include one or more processor(s) 114 and associated memory device(s) 116 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 116 of the spray controller 112 may generally comprise memory element(s) including, but not limited to, a computer readable medium (e.g., random access memory (RAM)), a computer readable non-volatile medium (e.g., a flash memory), a floppy disc, a compact disc-read only memory (CD-ROM), a magneto-optical disc (MOD), a digital versatile disc (DVD), and/or other suitable memory elements. Such memory device(s) 116 may generally be configured to store suitable computer-readable instructions that, when implemented by the processor(s) 114, configure the spray controller 112 to perform various computer-implemented functions, such as one or more aspects of the control logic 200 described below with reference to FIG. 4 and/or the method 300 described below with reference to FIG. 5. In addition, the spray controller 112 may also include various other suitable components, such as a communications circuit or module, one or more input/output channels, a data/control bus and/or the like.

The various functions of the spray controller 112 may be performed by a single processor-based device or may be distributed across any number of processor-based devices, in which instance such devices may be considered to form part of the spray controller 112. For instance, the functions of the spray controller 112 may be distributed across multiple application-specific controllers or computing devices.

Moreover, the computing system 110 may include one or more nozzle controllers 108. As mentioned above, each nozzle controller 108 may, in turn, be positioned within one of the nozzle assemblies 38 of the sprayer 10. For example, as shown in FIG. 2, in one embodiment, each nozzle controller 108 may be positioned within the nozzle body 40 of one of the nozzle assemblies 38. As will be described below, each nozzle controller 108 may be configured to receive control signals from the spray controller 112 and control the operation of the corresponding nozzle assembly 38 based on the received control signals.

Referring to FIG. 3, the nozzle controller(s) 108 may comprise any suitable processor-based device known in the art, such as a computing device or any suitable combination of computing devices. Thus, in several embodiments, each nozzle controller 108 may include one or more processor(s) 118 and associated memory device(s) 120 configured to perform a variety of computer-implemented functions. Such memory device(s) 120 may generally be configured to store suitable computer-readable instructions that, when implemented by the processor(s) 118, configure the corresponding nozzle controller 108 to perform various computer-implemented functions. In addition, each nozzle controller 108 may also include various other suitable components, such as a communications circuit or module, one or more input/output channels, a data/control bus and/or the like.

The various functions of the nozzle controller(s) 108 may be performed by a single processor-based device or may be distributed across any number of processor-based devices, in which instance such devices may be considered to form part of the nozzle controller(s) 108. For instance, the functions of the nozzle controller(s) 108 may be distributed across multiple application-specific controllers or computing devices.

Moreover, the computing system 110 and/or the system 100 may include various communicative links 122, 124, 126, 128. Specifically, in several embodiments, a communicative link 122 may communicatively couple the spray controller 112 and the nozzle controller(s) 108. In this respect, the spray controller 112 may be configured to transmit control signals to each nozzle controller 108 via the communicative link 122. As will be described below, such control signals may, in turn, instruct each nozzle controller 108 to control the operation of the actuator 102 of the corresponding nozzle assembly 38 (e.g., via communicative links 124, 126). For example, in one embodiment, upon receipt of the signals from the spray controller 112, each nozzle controller 108 may be configured to transmit control signals to the switching element 106 of the corresponding nozzle assembly 38 via the corresponding communicative link 124, 126.

Furthermore, in several embodiments, a communicative link 128 may communicatively couple the spray controller 112 and the actuator(s) 102 of the nozzle assembly(ies) 38. In this respect, the spray controller 112 may be configured to directly control the operation of the actuator 102 of each nozzle assembly 38 via the communicative link 128 independently of the corresponding nozzle controller 108. For example, in some embodiments, the communicative link 128 may communicatively couple the spray controller 112 and the switching element 106 of each nozzle assembly 38. As such, the spray controller 112 may be configured to directly control the operation of the switching element 106 of each nozzle assembly 38 via the communicative link 128. Thus, using the communicative link 128, the spray controller 112 may bypass the nozzle controller(s) 108 and control the operation of the actuator(s) 102 (e.g., by actuating the switching element(s) 106) directly and independently of the nozzle controller(s) 108.

Moreover, different communications protocol may be used to communicate over the communicative links 122, 128. For example, in one embodiment, the spray controller 112 may be configured to transmit the control signals to the nozzle controller(s) 108 via the communicative link 122 using a first communications protocol, such as CAN bus. Furthermore, in such an embodiment, the spray controller 112 may be configured to directly control the operation of the actuator(s) 102 of each nozzle assembly 38 via the communicative link 128 using a second (and different) communications protocol, such as Modbus. However, in alternative embodiments, any suitable communications protocols may be used to communicate over the communicative links 122, 128.

Additionally, the system 100 may include one or more sensor(s) 130. More specifically, the sensor(s) 130 may be configured to capture data indicative of one or more agronomic parameters of the field, such as the presence of weeds or nitrogen deficiencies. Furthermore, the sensor(s) 130 may be communicatively coupled to the spray controller 112 of the computing system 110 via a communicative link 132. As such, the data captured by the sensor(s) 130 may be transmitted to the spray controller 112 over the communicative link 132. In this respect, as will be described below, the spray controller 112 may be configured to determine when various agronomic conditions are present (e.g., weeds, nitrogen deficiencies, etc.) based on the data received from the sensor(s) 130.

The sensor(s) 130 may correspond to any suitable sensing device(s) configured to capture data indicative of the agronomic parameter(s) of the sprayer 10 within the field. For example, in several embodiments, the sensor(s) 130 may include an imaging device(s), such as an RGB camera(s), a fluorescence-based camera(s)/sensor(s), or a LIDAR sensor(s). In some embodiments, the images captured by the sensor(s) 130 may be analyzed to identify the presence of weeds and/or nitrogen deficiencies within the field. Alternatively, or additionally, the sensor(s) 130 may include other passive or emissive sensor(s).

Referring now to FIG. 4, a flow diagram of one embodiment of example control logic 200 that may be executed by the spray controller 112 of the computing system 110 (or any other suitable computing system) for controlling nozzle operation of an agricultural sprayer is illustrated in accordance with aspects of the present subject matter. Specifically, the control logic 200 shown in FIG. 4 is representative of steps of one embodiment of an algorithm that can be executed to control nozzle operation of an agricultural sprayer in a manner that allows the nozzle assemblies of the sprayer to be turned on quickly upon identification of an agronomic condition (e.g., weed or nitrogen deficiency presence), while still allowing for the nozzle assemblies to be independently controlled. Thus, in several embodiments, the control logic 200 may be advantageously utilized in association with a system installed on or forming part of an agricultural sprayer to allow for real-time nozzle operation control without requiring substantial computing resources and/or processing time. However, in other embodiments, the control logic 200 may be used in association with any other suitable system, application, and/or the like for controlling nozzle operation of an agricultural sprayer.

As shown in FIG. 4, at (202), the control logic 200 includes receiving sensor data indicative of an agronomic parameter of the field. Specifically, as mentioned above, in several embodiments, the spray controller 112 of the computing system 110 may be communicatively coupled to the sensor(s) 130 via the communicative link 132. In this respect, as the sprayer 10 travels across the field to perform a spraying operation thereon, the spray controller 112 may receive data from the sensor(s) 130. Such data may, in turn, be indicative of one or more agronomic parameters or conditions associated with the field, such as the presence of weeds or nitrogen deficiencies. For example, as mentioned above, in some embodiments, the sensor(s) 130 may include an imaging device(s). In such embodiments, the spray controller 112 may receive images or other image data from the sensor(s) 130.

Furthermore, at (204), the control logic 200 includes analyzing the received sensor data. Specifically, in several embodiments, the spray controller 112 may analyze the sensor data received at (202) to one or more agronomic conditions (e.g., weeds or nitrogen deficiencies) present within the field. As will be described, the agronomic condition(s) identified at (204) may be used to determine how the spray controller 112 controls the operation of the nozzle assemblies 38. For example, when the sensor data is received from an imaging device(s), the spray controller 112 may analyze the received images to determine the identify weeds or nitrogen deficiencies within the field, e.g., based on the color, gradients, fluorescence, and/or the like of the features depicted within the images. However, in further embodiments, the spray controller 112 may be determine the agronomic parameters of the field in any other suitable manner.

Additionally, at (206), the control logic 200 includes determining when a weed is present within the field. For example, the spray controller 112 may determine when a weed is present based the analysis of the sensor data at (204).

When it is determined at (206) that a weed is present, the control logic 200 includes, at (208), turning on or otherwise activating a nozzle assembly(ies) of the agricultural sprayer via a second communicative link. More specifically, when a weed is identified, it is desirable to turn on the nozzle assemblies 38 as quickly as possible to dispense the agricultural fluid onto the weed before the sprayer passes the weed. As such, in several embodiments, the spray controller 112 may directly control the operation of the actuator(s) 102 of the nozzle assembly(ies) 38 via the communicative link 128 (e.g., using the Modbus communications protocol). For example, in one embodiment, the spray controller 112 may transmit controls signals over the communicative link 128 directly to the switching element(s) 106 of the nozzle assembly(ies) 38. Upon receipt of such control signals, the switching element(s) 106 controls the supply of power to the solenoid(s) 104 to move the valve(s) 44 to the opened position(s). Thus, in such instances, the spray controller 112 bypasses the nozzle controller(s) 108 to turn on the nozzle assembly(ies) 38 much quicker than could be done with the communicative link 122 and the nozzle controller(s) 108. Thereafter, the control logic 200 returns to (202).

Conversely, when it is determined at (206) that a weed is not present, the control logic 200 includes, at (210), determining when a nitrogen deficiency is present within the field. For example, the spray controller 112 may determine when a nitrogen deficiency is present based the analysis of the sensor data at (204).

When it is determined at (210) that a nitrogen deficiency is present within the field, the control logic 200 includes, at (212), turning on the nozzle assembly(ies) via the second communicative link. More specifically, when a nitrogen deficiency is present, it is desirable to turn on the nozzle assembly(ies) 38 as quickly as possible to avoid having sections of the nitrogen deficient portion of the field on which no agricultural fluid was applied. As such, in several embodiments, the spray controller 112 may directly control the operation of the actuator(s) 102 of the nozzle assembly(ies) 38 via the communicative link 128 (e.g., using the Modbus communications protocol). For example, in one embodiment, the spray controller 112 may transmit controls signals over the communicative link 128 directly to the switching element(s) 106 of the nozzle assembly(ies) 38 via the communicative link 128. Upon receipt of such control signals, the switching element(s) 106 control the supply of power to the solenoid(s) 104 to move the valve(s) 44 to the opened position(s). Thus, in such instances, the spray controller 112 bypasses the nozzle controller(s) 108 to turn the nozzle assembly(ies) 38 much quicker than could be done with the communicative link 122 and the nozzle controller(s) 108. Thereafter, the control logic 200 returns to (202).

Conversely, when it is determined at (210) that a nitrogen deficiency is not present within the field, the control logic 200 includes, at (216), transmitting control signals to the nozzle controller(s) via a first communicative link. More specifically, when weeds and nitrogen deficiencies are not present, it is desirable to independently control the operation of each nozzle assembly 38. In such instances, the spray controller 112 may transmit control signals to the nozzle controller(s) 108 via the communicative link 122 (e.g., using a CAN bus communications protocol). Based on the received control signals, each nozzle controller 108 may control the operation of corresponding nozzle assembly 38. For example, in one embodiment, the nozzle controller(s) 108 may transmits controls signals over the communicative links 124, 126 to the switching element(s) 106 of the nozzle assembly(ies) 38. Upon receipt of such control signals, the switching element(s) 106 control the supply of power to the solenoid(s) 104, thereby adjusting the duty cycle of the valve(s) 44. Thus, in such instances, the use of the communicative link 122 and the nozzle controller(s) 108 allows the nozzle assembly(ies) 38 to be independently controlled from each other based on the specific conditions of the portion of the field underlying that nozzle assembly 38. Thereafter, the control logic 200 returns to (202).

Referring now to FIG. 5, a flow diagram of one embodiment of a method 300 for controlling nozzle operation of an agricultural sprayer is illustrated in accordance with aspects of the present subject matter. In general, the method 300 will be described herein with reference to the agricultural sprayer 10 and the system 100 described above with reference to FIGS. 1-4. However, it should be appreciated by those of ordinary skill in the art that the disclosed method 300 may generally be implemented with any agricultural sprayer having any suitable sprayer configuration and/or within any system having any suitable system configuration. In addition, although FIG. 5 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 5, at (302), the method 300 may include receiving, with a spray controller, sensor data indicative of the presence of a weed or the presence of a nitrogen deficiency. For example, as described above, the spray controller 112 of the computing system 110 may receive data from the sensor(s) 130 via the communicative link 132. Such sensor data may, in turn, be indicative of the presence of a weed or a nitrogen deficiency within the field during a spraying operation.

Additionally, at (304), the method 300 may include identifying, with the spray controller, the presence of the weed or the presence of the nitrogen deficiency based on the received sensor data. For example, as described above, the spray controller 112 may the presence of a weed or a nitrogen deficiency based on the received sensor data.

Moreover, as shown in FIG. 5, at (306), when it is determined that the weed or the nitrogen deficiency is not present within the field, the method 300 may include transmitting, with the spray controller, control signals to a nozzle controller via a first communicative link. For example, as described above, when it is determined that weeds or the nitrogen deficiencies are not present within the field, the spray controller 112 may transmit control signals to the nozzle controller(s) 108 via the communicative link 122. Such control signals may, in turn, instruct the nozzle controller(s) 108 to control the operation of the actuator(s) 102 of the nozzle assembly(ies) 38.

Furthermore, at (308), when it is determined that the weed or the nitrogen deficiency is present within the field, the method 300 may include directly controlling, with the spray controller, the operation of an actuator of a nozzle assembly of the agricultural sprayer via a second communicative link independent of the nozzle controller. For example, as described above, when it is determined that a weed or a nitrogen deficiency is present within the field, the spray controller 112 may directly control the operation of the actuator(s) 102 of the nozzle assembly(ies) 38 via the second communicative link 128 independently of the nozzle controller(s) 108.

It is to be understood that the steps of the control logic 200 and the method 300 are performed by the computing system 110 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the computing system 110 described herein, such as the control logic 200 and the method 300, is implemented in software code or instructions which are tangibly stored on a tangible computer readable medium. The computing system 110 loads the software code or instructions via a direct interface with the computer readable medium or via a wired and/or wireless network. Upon loading and executing such software code or instructions by the computing system 110, the computing system 110 may perform any of the functionality of the computing system 110 described herein, including any steps of the control logic 200 and the method 300 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. An agricultural sprayer, comprising:
a frame;
a tank supported on the frame, the tank configured to store an agricultural fluid;
a boom assembly coupled to the frame, the boom assembly including a nozzle assembly configured to dispense the agricultural fluid onto an underlying field, the nozzle assembly including a nozzle body, a valve moveably positioned within the nozzle body, and an actuator configured to move the valve within the nozzle body between an opened position and a closed position; and
a computing system including a spray controller positioned outside of the nozzle body and a nozzle controller positioned within the nozzle body, the spray controller being communicatively coupled to the nozzle controller such that the spray controller is configured to transmit control signals to the nozzle controller via a first communicative link, the nozzle controller being configured to control an operation of the actuator based on the control signals received from the spray controller, the spray controller being communicatively coupled to the actuator such that the spray controller is configured to directly control the operation of the actuator via a second communicative link independently of the nozzle controller.

2. The agricultural sprayer of claim 1, wherein:
the nozzle assembly corresponds to a first nozzle assembly, the boom assembly further including a second nozzle assembly configured to dispense the agricultural fluid onto the underlying field, the second nozzle assembly including a nozzle body, a valve moveably positioned within the nozzle body, and an actuator configured to move the valve within the nozzle body between an opened position and a closed position; and
the spray controller is further communicatively coupled to the actuator of the second nozzle assembly such that the spray controller is configured to directly control an operation of the actuator of the second nozzle assembly via the second communicative link.

3. The agricultural sprayer of claim 1, wherein the actuator comprises a solenoid configured to move the valve between the opened position and the closed position and a switching element configured to control a supply of power to the solenoid.

4. The agricultural sprayer of claim 3, wherein the spray controller is configured to directly control an operation of the switching element via the second communicative link.

5. The agricultural sprayer of claim 1, further comprising:
a sensor communicatively coupled to the spray controller, the sensor configured to capture data indicative of an agronomic parameter of the field.

6. The agricultural sprayer of claim 5, wherein the agronomic parameter comprises a presence of a weed or a presence of a nitrogen deficiency.

7. The agricultural sprayer of claim 6, wherein the spray controller is configured to:
identify the presence of the weed or the presence of the nitrogen deficiency based on the data captured by the sensor;
transmit control signals to the nozzle controller via the first communicative link instructing the nozzle controller to control the operation of the nozzle assembly when it is determined that the weed or the nitrogen deficiency is not present; and
directly control the operation of the actuator via the second communicative link when it is determined that the weed or the nitrogen deficiency is present.

8. The agricultural sprayer of claim 6, wherein the sensor comprises an imaging device.

9. The agricultural sprayer of claim 1, wherein the spray controller is configured to transmit control signals to the nozzle controller via the first communicative link using a first communications protocol and control the operation of the actuator via the second communicative link using a second communications protocol, the second communications protocol being different than the first communications protocol.

10. The agricultural sprayer of claim 9, wherein the first communications protocol is CAN bus and the second communications protocol comprises Modbus.

11. A system for controlling nozzle operation of an agricultural sprayer, the system comprising:
a nozzle assembly configured to dispense an agricultural fluid onto an underlying field, the nozzle assembly including a nozzle body, a valve moveably positioned within the nozzle body, and an actuator configured to move the valve within the nozzle body between an opened position and a closed position; and
a computing system including a spray controller positioned outside of the nozzle body and a nozzle controller positioned within the nozzle body, the spray controller being communicatively coupled to the nozzle controller such that the spray controller is configured to transmit control signals to the nozzle controller via a first communicative link, the nozzle controller being configured to control an operation of the actuator based on the control signals received from the spray controller, the spray controller being communicatively coupled to the actuator such that the spray controller is configured to directly control the operation of the actuator via a second communicative link independently of the nozzle controller.

12. The system of claim 11, wherein the actuator comprises a solenoid configured to move the valve between the opened position and the closed position and a switching element configured to control a supply of power to the solenoid.

13. The system of claim 12, wherein the spray controller is configured to directly control an operation of the switching element via the second communicative link.

14. The system of claim 11, further comprising:
a sensor communicatively coupled to the spray controller, the sensor configured to capture data indicative of an agronomic parameter of the field.

15. The system of claim 14, wherein the agronomic parameter comprises a presence of a weed or a presence of a nitrogen deficiency.

16. The system of claim 15, wherein the spray controller is configured to:
identify the presence of the weed or the presence of the nitrogen deficiency based on the data captured by the sensor;
transmit control signals to the nozzle controller via the first communicative link instructing the nozzle controller to control the operation of the nozzle when it is determined that the weed or the nitrogen deficiency is not present; and
directly control the operation of the actuator via the second communicative link when it is determined that the weed or the nitrogen deficiency is present.

17. The system of claim 14, wherein the sensor comprises an imaging device.

18. The system of claim 11, wherein the spray controller is configured to transmit control signals to the nozzle controller via the first communicative link using a first communications protocol and control the operation of the actuator via the second communicative link using a second communications protocol, the second communications protocol being different than the first communications protocol.

19. The system of claim 17, wherein the first communications protocol is CAN bus and the second communications protocol comprises Modbus.

20. A method for controlling nozzle operation of an agricultural sprayer, the agricultural sprayer including a nozzle assembly having a nozzle body, the agricultural sprayer further including a computing system having a spray controller positioned outside of the nozzle body and a nozzle controller positioned within the nozzle body, the method comprising:
receiving, with the spray controller, sensor data indicative of a presence of a weed or a presence of a nitrogen deficiency within the field;
identifying, with the spray controller, the presence of the weed or the presence of the nitrogen deficiency based on the received sensor data;
when it is determined that the weed or the nitrogen deficiency is not present, transmitting, with the spray controller, control signals to the nozzle controller via a first communicative link, the control signals instructing the nozzle controller to control an operation of an actuator of the nozzle assembly; and
when it is determined that the weed or the nitrogen deficiency is present, directly controlling, with the spray controller, the operation of the actuator via a second communicative link independent of the nozzle controller.
